(19) United States
(12) Patent Application Publication
(10) Pub. No.: US 2011/0186708 A1
(43) Pub. Date: Aug. 4, 2011

(54) COMPUTER SYSTEM RESTRAINT COLLAR

(76) Inventor: Ed Scott, Salt Lake City, UT (US)

(21) Appl. No.: 13/020,150

(22) Filed: Feb. 3, 2011

Related U.S. Application Data
(60) Provisional application No. 61/301,110, filed on Feb. 3, 2010.

(51) Int. Cl. F16M 13/00; E05B 73/00

(52) U.S. Cl. 248/551

(57) ABSTRACT

A computer restraint collar provides a rigid arm which extends around the base of a computer monitor or all-in-one computer to secure the same. The arm is attached to a base which is bolted or otherwise secured to a table or desk. The restraint collar better secures the computer against theft, and secures the computer against falling over.

### PRIORITY

The present application claims the benefit of U.S. Provisional Application Ser. No. 61/301,110, filed Feb. 3, 2010, which is herein incorporated by reference in its entirety.

### THE FIELD OF THE INVENTION

The present invention relates to computer security. More specifically, the present invention relates to a device for preventing the theft of a computer system or computer monitor as well as preventing damage to the computer or surrounding items.

### BACKGROUND

In many cases, it is desirable to secure a computer system. For example, many computer systems are used in public locations such as university unions and libraries. In these locations, it is desirable to secure the computer system against theft. These computers are often secured with a security cable which loops through the table or desk and attaches to a small slot in the computer.

While these locks are useful, they have their limitations. For example, computer monitors or integral or all-in-one computer systems (where the processor is integrated into the monitor) such as the iMac® are not well secured by a cable lock. Additionally, the cable can easily be cut with a relatively small cable or wire cutter. It is desirable to have a more secure computer lock which is more tamper resistant.

Another limitation of the available cable locks is that they do not protect the computer or surrounding items from caused by the computer falling. Various events such as earthquakes or simply bumping into a computer or desk may cause a computer or computer monitor to fall over. This often breaks the computer or monitor, and may also cause damage to surrounding items.

Other attempts have been made to secure computer monitors or the like. These other locks, however, have disadvantages. Many of these locks require the use of a specially designed desk or table and do not work with an ordinary table or counter space. Other locks are bulky and interfere with the use of the computer.

There is a need for a computer restraint device which better protects a computer from theft. There is a need for a computer restraint device which protects a computer from falling over or moving and falling off of a desk. There is a need for a computer restraint device which may be used with any ordinary table or counter and which does not interfere with the use of the computer.

### SUMMARY OF THE INVENTION

It is an object of the present invention to provide an improved computer restraint device.

According to one aspect of the invention, a restraint collar is provided. The collar has a rigid arm which extends around the base of a monitor or an integrated computer system to secure the device. The arm is attached to a mounting base which is rigidly attached to the table or desk which holds the computer. The arm extends out from the mounting base generally parallel to the desk, and keeps the computer or computer monitor against the desk and confined to a limited location on the desk. The restraint device thus prevents the computer from falling over or moving significantly if it is bumped into or if an earthquake occurs. The restraint device thus provides security in locations where a computer or computer monitor is at risk of falling over.

These and other aspects of the present invention are realized in a computer restraint device as shown and described in the following figures and related description.

### BRIEF DESCRIPTION OF THE DRAWINGS

Various embodiments of the present invention are shown and described in reference to the numbered drawings wherein:

FIG. 1 shows a top view of a computer restraint collar of the present invention;

FIG. 2 shows a side view of the restraint collar of FIG. 1; and

FIG. 3 shows a side view of the restraint collar of FIG. 1 in use.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

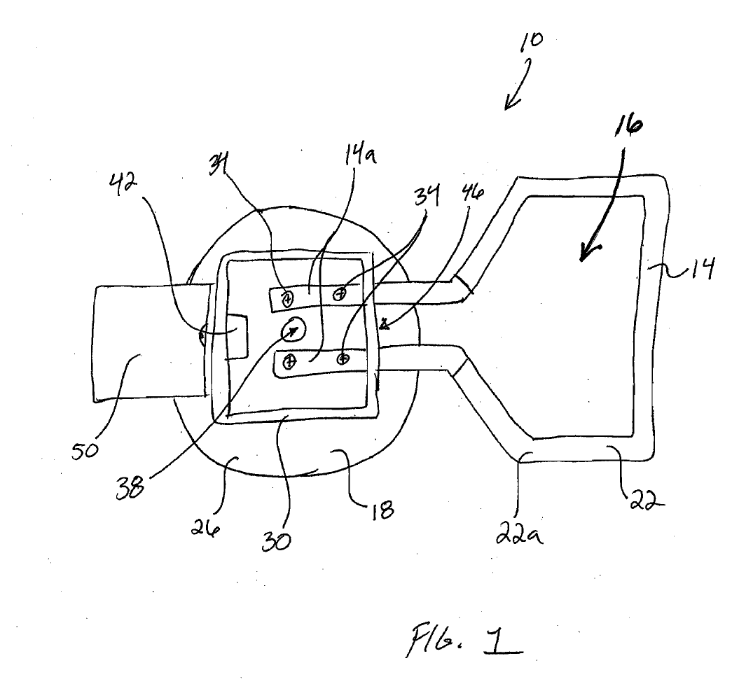

Turning now to FIG. 1, a top view of a computer restraint collar 10 according to the present invention is shown. The collar 10 includes a restraint arm 14 and a mounting base 18. The arm 14 forms an enclosed loop 22 which extends around the base of a computer monitor or the base of an all-in-one computer. As used herein, an all-in-one computer refers to a computer which includes the computer processor and hardware packaged in the monitor such that the monitor unit includes substantially the entire computer. An example of an all-in-one computer is the iMac® computer made by the Apple corporation. Herein, for convenience in discussing the invention, the term ‘monitor’ is used to refer to computer monitors and an all-in-one computer contained within a monitor as described above.

The restraint collar 10 is particularly useful with monitors, the loop 22 fitting around the pedestal base of the monitor to secure the monitor to a desk or counter surface. The arm 14 is typically formed from a solid steel or aluminum bar, and the loop 22 may be coated in a plastic or rubber to protect the computer or monitor. Except where noted, the restraint collar 10 is typically made of metal so as to be durable and tamper resistant. By way of example, the loop may be between 4 and 6 inches wide and extend between 6 and 10 inches from the mounting base 18. The opening 16 formed by the loop is often about 2 inches by 4 to 6 inches in size, accommodating the pedestal base of a monitor. The arm 14 may be formed of ⅜ inch aluminum.

The base 18 includes a base plate 26 which is secured against a table or desk and a box portion 30 which extends upwardly from the base plate 26. The box lid is removed to show the interior details of the box 30. The ends 14a of the arm 14 are passed through close fitting holes in the front of the box 30 and secured to the base plate 26 by bolts 34 or the like. A hole 38 is formed in the center of the base plate 26 to facilitate attachment of the base 18 to a desk or table with a bolt or screw. The box 30 has a tab 42 and slot 46 to allow a lid to be secured to the box 30 with a lock.

As such, the restraint device 10 has a mounting base portion, a restraint arm, and a locking cover. The mounting base is bolted or otherwise attached to a desk or desired surface. The restraint arm is a rigid arm, typically formed from metal, and is attached to the base portion. The mounting arm extends horizontally outward from the base portion, typically by 6 to 10 inches, and forms a loop to enclose the pedestal base of a monitor. The locking cover is attached to the base and is locked thereto with a key. The cover prevents access to the bolts which secure the restraint arm to the base and which secure the base to the desk, preventing people from tampering with the restraint device and stealing the monitor.

A clamping bracket 50 may be attached to the back of the box 30. The clamping bracket 50 allows the base 18 to be secured to a desk without penetrating through the top of the desk with a bolt or screw. The clamping bracket is primarily used where the concern is in preventing the computer from falling over rather than theft. When not used, the clamping bracket is removed from the base and the base is secured to a desk via hole 38.

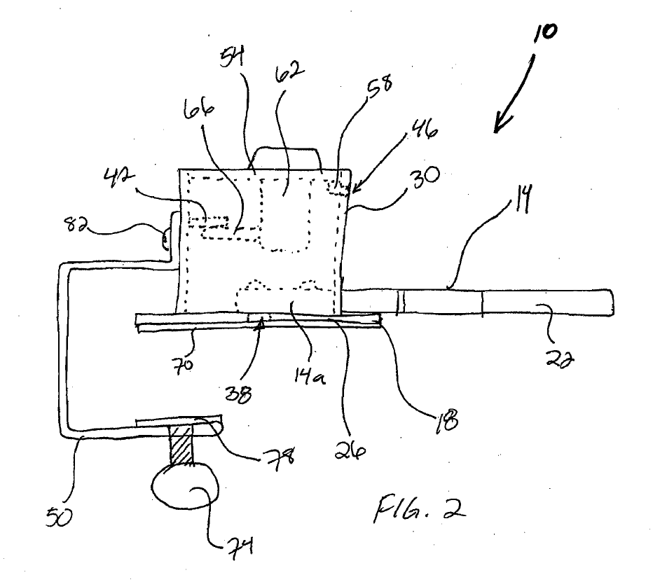

FIG. 2 shows a side view of the restraint collar 10. In use, a lid 54 is attached to the box 30 to prevent a person from tampering with the device. The arm bolts 34 as well as the desk connection hole 38 (and corresponding bolt or screw) are contained within the box 30, allowing the computer or monitor to be secured. The lid 54 includes a tab 58 which fits in the slot 46 in the front of the box 30 and a lock 62 with a locking arm 66 that can engage the tab 42 to secure the lid 54 to the box 30.

The base plate 26 may include a rubber pad 70 on the bottom thereof to help in securely attaching the base 18 to a desk and to prevent damage to the desk. The clamping arm 50 may use a thumb screw 74 that drives a padded clamping plate 78 to secure the base 18 to a desk. The clamping arm 50 is removably attached to the box 30 with a bolt 82, allowing the arm 50 to be adjusted and removed if desired. In use, the clamping arm 50 is used where the primary concern is to prevent the monitor from falling over, such as where earthquakes are likely or where the computer or monitor is located in a high traffic area. Where theft prevention is required, the base is bolted or screwed to a desk or other surface via hole 38. Preferably, the base 18 is so secured such that the fastener may only be accessed from inside of the box 30.

The arm 14 is formed in a shape where it extends parallel and close to the surface of a desk. It will be appreciated that the arm may be bent to extend further away from the desk surface, and may angle upwardly or downwardly to better match the base of a particular monitor or computer. It is often desirable that the arm 14, when installed, contacts the base of a monitor or computer and applies a small amount of force thereto to better prevent the monitor or computer from falling over.

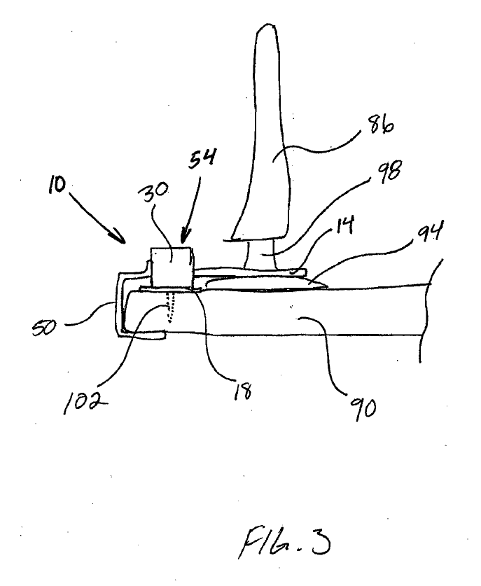

FIG. 3 shows the restraint collar 10 in use. The collar 10 is used to secure a monitor 86 to a table or desk 90. During installation, the arm 14 is removed from the base 18 and placed around the base of the monitor 86 such that the arm 14 is placed on top of the base plate 94 and around the base column 98. The column 98 is placed in the loop 16 of the restraint arm. The ends 14a of the arm 14 are then placed through the corresponding holes in the front of the box 30 and secured to the base plate 26 with bolts 34. The monitor 86 is then positioned as desired, and the base 18 is secured to the desk 90, either by the clamping arm 50 or preferably by a bolt or screw 102. The lid 54 is then locked in place on the box 30 so as to prevent tampering with the restraint collar 10.

The restraint collar 10 is advantageous as it both secures a computer from theft as well as helps to keep the computer or monitor from falling over. Many of the public locations where computers are placed, such as libraries or schools, experience substantial traffic and there is risk that a computer is bumped into and knocked over. Modern electronics are such that if a computer or monitor falls, it is most likely damaged and will need to be replaced. With the desire to use a larger monitor or an all-in-one computer, the cost of replacement is increased. The restraint arm extends generally parallel to the desk or surface on which the monitor in placed, and holds the monitor base against the surface. This provides a large measure of protection against the monitor falling over. Because the restraint arm 14 is made of a rigid metal, the arm does not easily bend or twist and can apply a significant force to the monitor to prevent it from falling.

The restraint device 10 is also advantageous as it keeps the monitor 86 in a desired location, preventing persons from moving the monitor. This helps to maintain a tidy appearance and keeps publicly available computer systems properly set up for patrons to use.

The restraint collar 10 is also advantageous as it eliminates the unsightly cables or chains used to secure computers or computer monitors. When prior art cable locks are used, the cable often dangles from the computer and desk in a loop, resulting in the risk that a person accidentally pulls on the cable and causes the computer or monitor to fall over. Where prior art cable locks were not able to secure a computer, chains have been used to secure the computer. Both cables and chains are unsightly, and the present invention provides a more attractive alternative. The restraint collar also better secures the computer or monitor because the metal arm 14 is more difficult to cut or damage than the cable of available locks.

There is thus disclosed an improved computer restraint collar. It will be appreciated that numerous changes may be made to the present invention without departing from the scope of the claims.

What is claimed is:

1. A computer restraint collar for mounting a monitor to a surface comprising:
a mounting base;
an attachment device for securing the base plate to a surface;
a restraint arm, the arm having a first end and a second end and being bent to form a loop, the first end and second end being attachable to the base such that, when attached, the loop extends outwardly from the base and extends generally parallel to the surface on which the base is mounted, and such that the loop is disposed around the base of a monitor or all-in-one computer; and
a locking cover, the cover being attachable to the with a lock so as to cover the attachment device securing the base to the surface and so as to cover the attachment of the first and second ends of the restraint arm to the base such that the locking cover prevents access to the attachment device and to the first and second ends.

2. The collar of claim 1, wherein the arm is rigid and wherein the arm is rigidly attached to the base plate.

3. The collar of claim 2, wherein the arm engages the base of said computer or monitor to prevent the computer or monitor from falling over.

4. The collar of claim 1, wherein the arm extends laterally from the mounting base such that said computer or monitor is spaced apart form the mounting base on said surface;

5. The collar of claim 2, wherein the arm presses the base of said computer or monitor against said surface.

6. The collar of claim 1, wherein the loop forms an opening having a size of about 2 inches or greater and said opening extends around the pedestal base of said computer or monitor.

7. The collar of claim 1, wherein the base has a box enclosure attached thereto, wherein the first and second ends of the restraint arm pass through openings in the box and are attached to the base inside of the box, and wherein the locking cover closes an access opening in the box to thereby prevent access to the first and second ends.

8. A computer restraint collar for securing a computer monitor or an all-in-one computer to a surface comprising:
a mounting base attachable to the surface;
a restraint arm, the restraint arm being formed of a rigid material and having a first end, a second end and a length of material therebetween, the restraint arm having the first end disposed adjacent the second end and forming a loop which is open between the first and second ends to allow the loop to be placed around the base of a computer or computer monitor, the first and second ends of the restraint arm being removably attached to the base such that the restraint arm extends therebetween; and
a cover attached to the base so as to prevent access to the first and second ends of the restraint arm and to the attachment of the base to the surface.

9. The collar of claim 8, wherein the restraint arm extends generally parallel to the surface and holds a computer or monitor against the surface.

10. The collar of claim 8, wherein the loop in the restraint arm is between about 2 and about 6 inches in size.

11. The collar of claim 8, wherein the base has a box attached thereto, wherein the first and second ends of the restraint arm pass through openings in a side of the box and are attached to the base, and wherein the cover closes an access opening in the box and prevents removal of the restraint arm from the base.

12. The collar of claim 8, wherein the first and second ends of the restraint arm are passed around the base of a computer or monitor to enclose the computer or monitor base in the loop and the restraint arm first and second ends are thereafter secured to the mounting base to prevent removal of the computer or monitor from the restraint arm.

13. The collar of claim 8, wherein the mounting base has a hole therethrough, wherein a fastener is placed through the hole to secure the mounting base to a surface, and wherein the cover covers the fastener to prevent removal thereof.

14. The collar of claim 8, wherein the restraint arm prevents significant movement of the computer or monitor.
